(19) United States
(12) Patent Application Publication
(10) Pub. No.: US 2012/0007703 A1
(43) Pub. Date: Jan. 12, 2012

(54) CURRENT LEAD ASSEMBLY FOR SUPERCONDUCTING MAGNET

(76) Inventors: Yan Zhao, Shanghai (CN); Xianrui Huang, Clifton Park, NY (US); Anbo Wu, Shanghai (CN); Evangelos Trifon Laskaris, Schenectady, NY (US); Paul St. Mark Shadforth Thompson, Niskayuna, NY (US); Chao Yang, Shanghai (CN); Jun Pan, Shanghai (CN); Susumu Mine, Niskayuna, NY (US)

(21) Appl. No.: 12/984,235

(22) Filed: Jan. 4, 2011

(30) Foreign Application Priority Data
Jan. 5, 2010 (CN) 2010100021

(51) Int. Cl. F25D 31/00; F17C 9/04; F25D 17/02; F17C 9/02; H01F 6/04; F17C 3/08

(52) U.S. Cl. 335/216; 62/259.2; 62/45.1; 62/64; 62/50.2

(57) ABSTRACT

A current lead assembly includes a current lead having an end, at least one heat station thermally coupled to the end, a cryogen-flow path extending through the heat station and comprising at least one connection, and a cryogen generation source fluidly coupled to the cryogen-flow path through the connection.

### BACKGROUND

1. Technical Field

Embodiments of the invention relate to current lead assemblies for superconducting magnets, and more specifically to a current lead assembly having a cooling system for cooling one end of the current lead that is electrically coupled to the superconducting magnet.

2. Discussion of Related Art

Superconducting magnets conduct electricity with effectively zero resistance as long as the magnets are maintained at a suitably low temperature, which is referred to as “superconducting temperature” hereinafter. Accordingly, cryogenic systems are used to ensure that the superconducting magnets work at the superconducting temperature.

Superconducting magnets generally comprise superconducting coils electrically coupled to a power supply through current leads for transmitting the electrical current to the superconducting coils. These current leads each comprise one end electrically coupled to the superconducting coil, and another end electrically coupled to the power supply. It has been realized that Joule heat (or ohmic heat) generated from the current leads may inevitably propagate to the superconducting coils. Accordingly, a cooling apparatus is used for cooling the end of the current leads electrically coupled to the superconducting coils (hereinafter referred to as a “cold end”). The other end that is electrically coupled to the power supply (hereinafter referred to as a “warm end”).

One type of cooling apparatus used for the current leads comprises a heat station which is in thermal contact with, but is electrically isolated from, the cold end of the current lead. The heat station usually comprises metal materials, such as pure copper or aluminum for example, with good thermal conductivities to form a thermal conduction path from the current lead to a cryocooler. The thermal conduction path is electrically separated by isolative elements such as one or more ceramic pads. These ceramic pads provide electric isolation and are soldered to the heat station to minimize the thermal resistance. However, the thermal resistance of the ceramic pads becomes higher as the temperature of the thermal conduction path decreases. Moreover, the bonding of the ceramic pads and the heat station is usually accomplished by soldering. This becomes unreliable as the bond may break due to mechanical and thermal stresses.

It may be desirable to have a current lead assembly with a cooling system that differs from those assemblies that are currently available for both effectively cooling the cold ends of the current leads, as well as electrically insulating the cooling system from the current leads.

### BRIEF DESCRIPTION

In accordance with one embodiment, a current lead assembly is provided. A current lead assembly includes a current lead having an end, at least one heat station thermally coupled to the end, a cryogen-flow path extending through the heat station and comprising at least one connection, and a cryogen generation source fluidly coupled to the cryogen-flow path through the connection.

In accordance with another embodiment, a superconducting magnet system includes at least one superconducting coil comprising a positive and a negative superconducting magnet terminal, a positive and a negative current leads each having an end electrically coupled to a corresponding one of the positive and negative superconducting magnet terminals, and a cooling system. The cooling system includes at least one heat station physically and thermally coupled to the ends of the positive and negative current leads, and a cryogen-flow path extending through the heat station.

In accordance with still another embodiment, a cooling method includes physically and thermally coupling a heat station to an end of a conductive current lead, coupling at least one connection tube to a through hole in the heat station to form a cryogen-flow path in the through hole and the connection tube, and flowing a liquid cryogen into the through hole through the connection tube.

### BRIEF DESCRIPTION OF THE DRAWING FIGURES

These and other features, aspects, and advantages of the present invention will become better understood when the following detailed description is read with reference to the accompanying drawings in which like characters represent like parts throughout the drawings, wherein:

FIG. 1 illustrates an exemplary superconducting magnet comprising a superconducting coil wound on a bobbin.

FIG. 2 illustrates a superconducting magnet system having a current lead assembly which includes a cooling system according to one embodiment of the invention.

FIG. 3 illustrates a superconducting magnet system having a current lead assembly which includes a cooling system according to another embodiment of the invention.

FIG. 4 illustrates a superconducting magnet system having a current lead assembly which includes a cooling system according to still another embodiment of the invention.

### DETAILED DESCRIPTION

Embodiments of the invention relate to a current lead assembly for a superconducting magnet. The current lead assembly comprises at least one positive current lead, at least one negative current lead, and a cooling system. Each of the positive and negative current leads has one end (“warm end”) electrically coupled to a power supply, and another end (“cold end”) electrically coupled to the superconducting magnet. The cooling system comprises a heat station in thermal contact with the cold ends of the current leads, and a cryogen-flow path extending through the heat station. A fluid cryogen flows in the cryogen-flow path, and removes heat from the cold end by converting the fluid cryogen into gas. Accordingly, the cold ends of the current leads are maintained at a low temperature and do not transmit heat to the superconducting magnet. The electric current is transmitted from the current leads to the positive and negative terminals of the superconducting coil at the cold end. The heat station maintains the cold end of the current leads at the superconducting temperature to ensure the superconducting operation of the coil terminals.

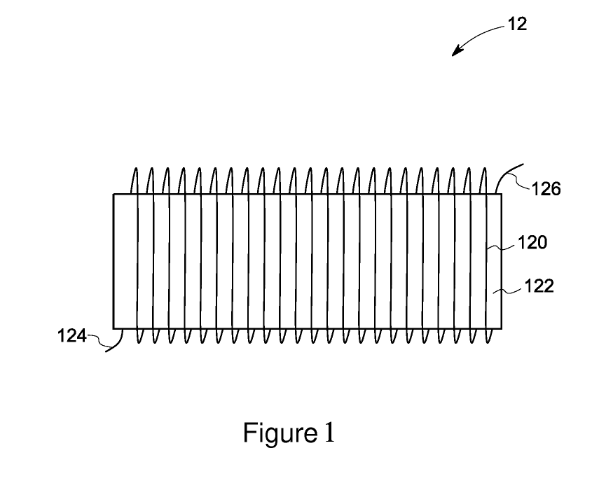

Referring to FIG. 1, an exemplary superconducting magnet 12 (“magnet 12”) comprises at least one superconducting magnet coil 120 wound on a support member such as a bobbin 122. In the illustrated embodiment, the superconducting magnet coil 120 comprises a positive and a negative magnet terminal 124, 126 for receiving an electrical current. In certain embodiments, the superconducting magnet coil 120 comprises superconducting material such as NbTi, Nb₃Sn, MgB₂, BSCCO, YBCO, and is maintained below a superconducting critical temperature such as about 5 Kelvin (K) to about 7 K. Accordingly, the superconducting magnet coil conducts electricity with very small electrical resistance. In certain embodiments, the magnet 12 may comprise a plurality of superconducting coils wound on the bobbin to obtain a desired magnet field and/or magnetic energy. In certain embodiments, the magnet 12 may further comprise an outer protection layer (not shown) wound around the superconducting coils.

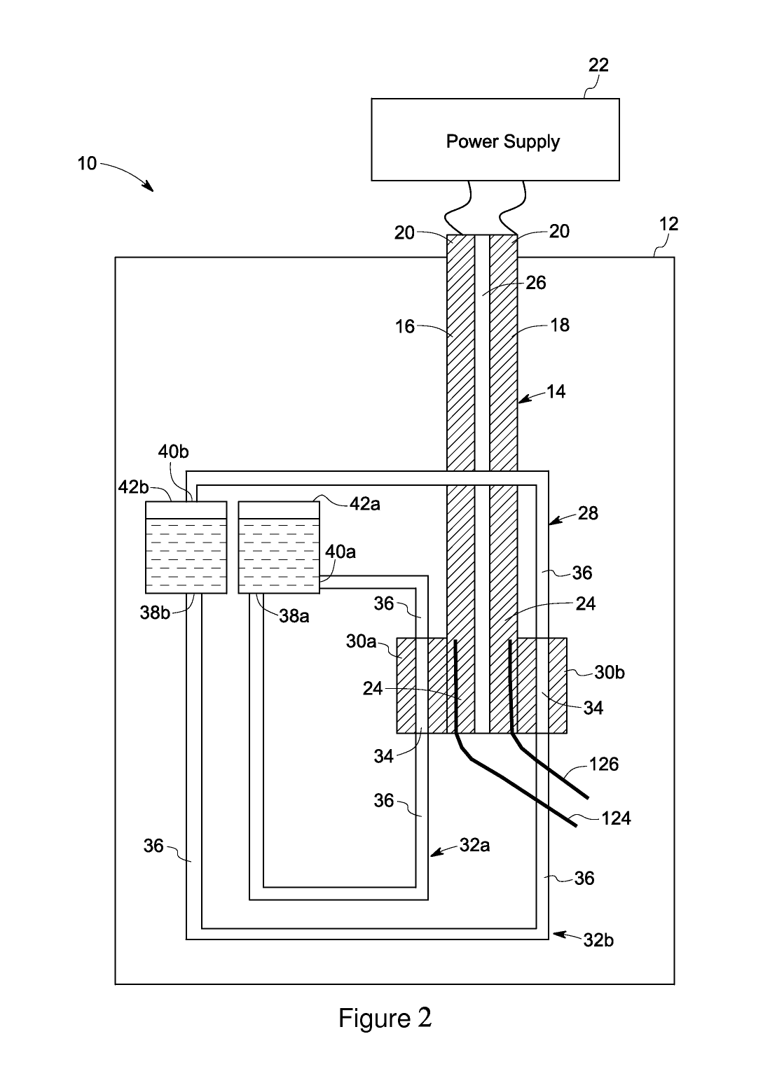

Referring to FIG. 2, an exemplary superconducting magnet system 10 comprises the magnet 12 and a current lead assembly 14 having a cooling system 28 according to one embodiment of the invention. For purpose of simplification of the view, the superconducting coil 122 and the bobbin 124 of the magnet 12 is omitted from FIGS. 2-4. In the illustrated embodiment, the current lead assembly 14 comprises at least one positive current lead 16 and at least one negative current lead 18. Each of the positive and negative current leads 16, 18 has a warm end 20 electrically coupled to a power supply 22, and a cold end 24 electrically coupled to the corresponding magnet terminal 124, 126 of the magnet 12 for transmitting electrical current from the power supply 22 to the magnet 12. In certain embodiments, the positive and negative current leads 16, 18 comprise copper, aluminum, brass, stainless steel, or some high temperature superconductive materials such as BSCCO or YBCO. In the illustrated embodiment, the current lead system 14 comprises an electrical insulator 26 between the positive and negative current leads 16, 18. In certain embodiments, the electrical insulator 26 comprises glass fiber composite or plastic materials. In other embodiments, the positive and negative current leads 16, 18 are spaced from each other and no insulator is necessary in such embodiments. In the illustrated embodiment, the current lead assembly 14 further comprises a current lead cooling system 28 (“cooling system 28”) for maintaining the cold ends 24 of the positive and negative current leads 16, 18 at a low temperature.

In the illustrated embodiment, the cooling system 28 comprises at least one heat station 30a, 30b thermally coupled to the cold ends 24 of the positive and negative current leads 16, 18, and at least one cryogen-flow path 32a, 32b extending through the heat stations 30a, 30b, respectively. A fluid cryogen flows in the cryogen-flow path, and removes heat from the cold ends 24 by converting the fluid cryogen into a gas. Accordingly, the cold ends 24 of the positive and negative current leads 16, 18 are maintained at a low temperature and do not transmit heat to the magnet 12. In certain embodiments, the liquid cryogen that flows in the at least one cryogen-flow path 32a, 32b comprises nitrogen, neon, hydrogen, helium, or any other suitable cryogen capable of withdrawing sufficient heat from the cold ends 24.

In the illustrated embodiment of FIG. 2, the at least one heat station 30a, 30b comprises a metal or a metal alloy with both high thermal conductivity and electrical conductivity. Examples of such a material include copper, aluminum, silver and brass. In the illustrated embodiment, the cooling system 28 comprises the first heat station 30a thermally coupled to the positive current lead 16 and the second heat station 30b thermally coupled to the negative current lead 18. In one embodiment, the heat stations and the current leads may be coupled through soldering, brazing or welding. In another embodiment, the first heat station 30a may be an integral portion of the positive current lead 16, and the second heat station 30b may be an integral portion of the negative current lead 18.

In the illustrated embodiment of FIG. 2, the cooling system 28 comprises the first cryogen-flow path 32a extending through the first heat station 30a, and the second cryogen-flow path 32b extending through the second heat stations 30b. As previously mentioned, the flow paths 32a, 32b transmit cryogen and are respectively thermally coupled to the first and second heat stations 30a, 30b. In the illustrated embodiment, each of the first and second cryogen-flow paths 32a, 32b pass through a through hole 34 in the corresponding heat stations 30a, 30b, and connection tubes 36 are soldered, welded or brazed to both ends of the through holes 34. Accordingly, the liquid cryogen in the cryogen-flow paths 32a, 32b directly contacts the heat stations 30a, 30b in the through holes 34, and effective cooling can be attained. In another embodiment, each of the first and second cryogen-flow paths 32a, 32b comprises an integral connection tube extending through the corresponding through hole 34 of corresponding heat station 30a, 30b. In certain embodiments, the connections tubes 36 comprise metal material such as stainless steel, copper or brass for example.

In certain embodiments, the first and second cryogen-flow paths 32a, 32b each comprise at least one connection for introducing a liquid cryogen into the path. In the illustrated embodiment of FIG. 2, the first and second cryogen-flow paths 32a, 32b each comprise a first connection 38a, 38b and a second connection 40a, 40b at opposite ends of the flow paths 32a, 32b. Accordingly, the first and second heat stations 30a, 30b are cooled by the liquid cryogen flowing through the first and second cryogen-flow paths 32a, 32b.

In the illustrated embodiment, the cooling system 28 comprises cryogen generation sources 42a, 42b respectively fluidly coupled to the first and second connections 38a, 38b, 40a, 40b of the first and second cryogen-flow paths 32a, 32b. In one embodiment, the cryogen generation sources comprise cryogen containers 42a, 42b storing liquid cryogen. The liquid cryogen flows from the cryogen containers 42a, 42b into the cryogen-flow paths 32a, 32b from the first connections 38a, 38b, and gases exit the first and second cryogen flow paths 32a, 32b from the second connections 40a, 40b. In the illustrated embodiment, the cryogen containers 42a, 42b are positioned above the first and second cryogen-flow paths 32a, 32b. Accordingly, the liquid cryogen flows form the cryogen containers 42a, 42b driven by gravity.

In the illustrated embodiment, the first and second cryogen-flow paths 32a, 32b receive liquid cryogen from different cryogen containers. In the illustrated embodiment, the first and second connections 38a, 38b, 40a, 40b of the first and second cryogen-flow paths 32a, 32b are fluidly coupled to the cryogen containers 42a, 42b. In other embodiments, only the first connections 38a, 38b may be fluidly coupled to the cryogen container 42a, 42b for receiving the liquid cryogen, and the second connections 40a, 40b may be coupled to another container to store the gas output from the first and second cryogen-flow paths 32a, 32b, or to a re-condenser for re-condensing the gas back into a liquid cryogen, or to vent out.

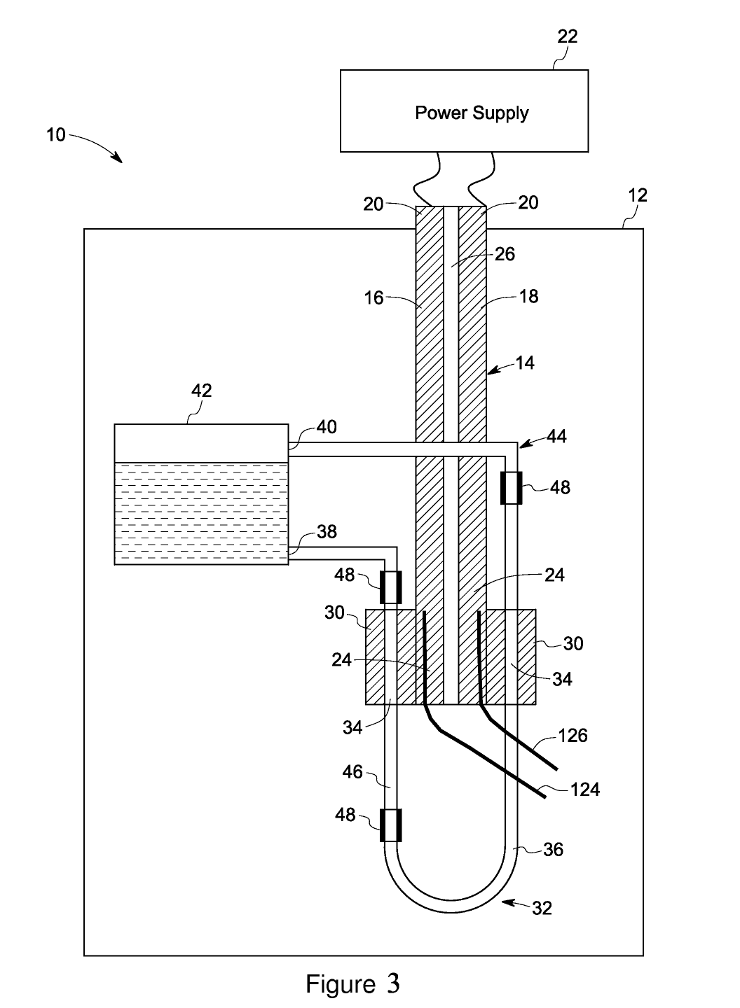

Referring to FIG. 3, a cooling system 44 according to another embodiment of the invention comprises one cryogen-flow path 46 extending through the first and second heat stations 30a, 30b and having at least one connection 38, 40 fluidly coupled to a cryogen container 42. Accordingly, the liquid cryogen flows in the cryogen-flow path 46 for cooling cold ends 24 of both positive and negative current leads 16, 18. In the illustrated embodiment, the cryogen-flow path 46 comprises at least one electrically isolative tube section 48 between the first and second heat stations 30a, 30b to form an electrical insulation between the first and second heat stations 30a, 30b. In certain embodiments, the electrically isolative tube section 48 may comprise ceramic material. One example of such an electrical isolative tube section 48 may comprise a ceramic portion and stainless steel coatings on opposite ends of the ceramic portion for ease of joining to adjacent connection tubes 36 by welding or brazing for example. In the illustrated embodiment, the cryogen flow path 46 comprises at least one electrically insulative tube section 48 between the cryogen container 42 and each heat station 30a, 30b to electrically isolate the cryogen container 48 from the current leads 16, 18.

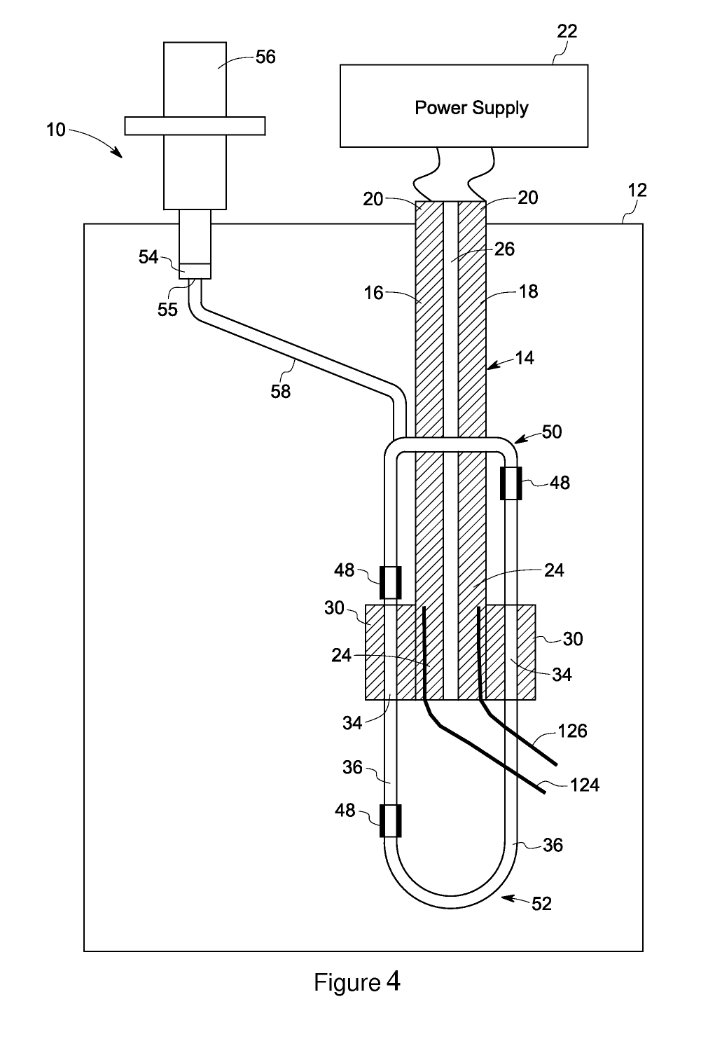

Referring to FIG. 4, a cooling system 50 according to still another embodiment of the invention comprises a cryogen-flow path 52 extending through the first and second heat stations 30a, 30b, and a cryogen generation source 54 fluidly coupled to the cryogen-flow path 52. In the illustrated embodiment, the cryogen generation source 54 comprises a re-condenser, which is associated with a refrigerator 56 for cooling the re-condenser to a low temperature. Accordingly, the cryogen generation source 54 provides a cold surface 55 for re-condensing the boiled-off gas back into its liquid state. In the illustrated embodiment, the cryogen generation source 54 is in fluid communication with the cryogen-flow path 52 through only one tube 58. In other embodiments, the cryogen generation source 54 may be coupled to the cryogen-flow path 52 through two or more tubes.

At a start-up operation of the cooling system, a certain amount of cryogen is introduced to the cryogen-flow path 52 from an inlet (not shown) which is later closed when adequate cryogen has been introduced in the cryogen flow path 52. In one embodiment, the cryogen introduced into the cryogen-flow path 52 is a liquid cryogen. In other embodiments, the cryogen introduced into the cryogen-flow path 52 is a gas and is continuously converted into the liquid cryogen by the cryogen generation source 54. During the normal cooling operation of the cooling system 50, the liquid cryogen flows in the cryogen-flow path 52. In certain embodiments, the through holes 34 in the first and second heat stations 30a, 30b are filled with liquid cryogen during the normal cooling operation of the cooling system 50 for maintaining the cold ends 24 of the current leads at the low temperature. Part of the liquid cryogen in the cryogen-flow path 32 is boiled-off as a gas to absorb heat from the cold ends 24 of the current leads 16, 18. The boiled-off gas flows to the cryogen generation source 54 and is converted into liquid cryogen which flows back into the cryogen-flow path 52. Accordingly, the conversion of the liquid cryogen and gas is automatically performed within the cooling system.

The embodiments described herein are examples of compositions, structures, systems, and methods having elements corresponding to the elements of the invention recited in the claims. This written description may enable those of ordinary skill in the art to make and use embodiments having alternative elements that likewise correspond to the elements of the invention recited in the claims. The scope of the invention thus includes compositions, structures, systems and methods that do not differ from the literal language of the claims, and further includes other structures, systems and methods with insubstantial differences from the literal language of the claims. While only certain features and embodiments have been illustrated and described herein, many modifications and changes may occur to one of ordinary skill in the relevant art. The appended claims cover all such modifications and changes.

1. A current lead assembly comprising:
a current lead having an end;
at least one heat station thermally coupled to the end;
a cryogen-flow path extending through the heat station and comprising at least one connection; and
a cryogen generation source fluidly coupled to the cryogen-flow path through the connection.

2. The assembly according to claim 1, wherein the heat station is thermally and electrically coupled to the end of the current lead.

3. The assembly according to claim 2, wherein the heat station is an integral portion of the current lead.

4. The assembly according to claim 1, wherein the assembly comprises a positive and a negative current lead, and wherein the assembly comprises a first and a second heat station respectively thermally coupled to the corresponding one of the positive and negative current leads.

5. The assembly according to claim 4, wherein the assembly comprises an electrical insulator between the positive and negative current leads.

6. The assembly according to claim 4, wherein the assembly comprises a first and a second cryogen-flow path respectively extending through the first and the second heat stations.

7. The assembly according to claim 4, wherein the assembly comprises one cryogen-flow path extending through both of the first and second heat stations.

8. The assembly according to claim 7, wherein the cryogen-flow path comprises at least one electrically isolative tube section between the first and second heat stations.

9. The assembly according to claims 8, wherein the electrically isolative tube section comprises a ceramic portion and stainless steel coating on opposites ends of the ceramic portion.

10. The assembly according to claim 1, wherein the cryogen-flow path comprises at least one electrically isolative tube section between the heat station and the cryogen generation source.

11. The assembly according to claim 1, wherein the cryogen generation source is a liquid cryogen container.

12. The assembly according to claim 1, wherein the cryogen generation source is a re-condenser having a cold surface in fluid communication with the cryogen flow path.

13. The assembly according to claim 1, wherein the cryogen-flow path comprises a through hole in the heat station, and at least one connection tube fluidly coupled to the through hole.

14. A superconducting magnet system comprising:
at least one superconducting coil comprising a positive and a negative superconducting magnet terminal;
a positive and a negative current leads each having an end electrically coupled to a corresponding one of the positive and negative superconducting magnet terminals; and
a cooling system comprising:
at least one heat station physically and thermally coupled to the ends of the positive and negative current leads; and
a cryogen-flow path extending through the heat station.

15. The system of claim 14, wherein the cooling system further comprises a re-condenser having a cold surface fluidly coupled to the cryogen flow path.

16. The system of claim 15, wherein the cryogen-flow path comprises at least one electrically isolative tube section between the heat station and the re-condenser.

17. The system of claim 14, wherein the cooling system comprises a first and a second heat stations respectively physically and thermally coupled to the end of the corresponding positive and negative current leads.

18. The system of claim 17, wherein the cryogen-flow path extending through both of the first and second heat stations, and the wherein the cryogen-flow path comprises at least one electrically isolative tube section between the first and second heat stations.

19. A cooling method comprising:
physically and thermally coupling a heat station to an end of a conductive current lead;
coupling at least one connection tube to a through hole in the heat station to form a cryogen-flow path in the through hole and the connection tube; and
flowing a liquid cryogen into the through hole through the connection tube.

20. The method of claim 19 further comprising fluidly coupling a re-condenser to the cryogen-flow path, and re-condensing boiled-off gas from the cryogen-flow path back into a liquid cryogen to flow into the cryogen flow path.

21. The method of claim 19 further comprising fluid coupling a liquid cryogen container to the cryogen-flow path, flowing the liquid cryogen from the liquid cryogen container to the cryogen-flow path, and flowing boiled-off gas to the liquid cryogen container.

22. The method of claim 19, wherein physically and thermally coupling a heat station to the end of the current lead comprises producing a current lead having an integral heat station adjacent to said end.
